(19) United States
(12) Patent Application Publication
(10) Pub. No.: US 2021/0181572 A1
(43) Pub. Date: Jun. 17, 2021

(54) DISPLAY APPARATUS

(71) Applicant: Innolux Corporation, Miao-Li County (TW)

(72) Inventors: Jiou-Teng Lai, Miao-Li County (TW); Chiung-Chieh Kuo, Miao-Li County (TW); Kuan-Hung Kuo, Miao-Li County (TW); Chiu-Lien Yang, Miao-Li County (TW)

(73) Assignee: Innolux Corporation, Miao-Li County (TW)

(21) Appl. No.: 17/114,511

(22) Filed: Dec. 8, 2020

(30) Foreign Application Priority Data
Dec. 16, 2019 (CN) 201911295506.9

(51) Int. Cl. G02F 1/1335; G02F 1/1333; G06F 3/041

(52) U.S. Cl. CPC G02F 1/133514; G02F 1/133528; G02F 1/13338; G02F 2201/50; G06F 3/0416; G02F 2202/28; G06F 3/0412

(57) ABSTRACT

A display apparatus is provided. The display apparatus of an embodiment includes a panel and a filter film. The filter film is disposed on the panel, and a resistance of the filter film is between 10³ ohm/sq and 10¹⁰ ohm/sq. A transmittance of the filter film in a wavelength range from 380 nm to 420 nm is less than 100%. The display apparatus of an embodiment includes a panel, a polarizer, and a filter film. The polarizer is disposed on the panel. A transmittance of the filter film in a wavelength range from 380 nm to 420 nm is less than 100%. The display apparatus of the disclosure may reduce the transmittance of short-wavelength light and improve display quality and reliability.

### CROSS-REFERENCE TO RELATED APPLICATION

This application claims the priority benefit of China application serial no. 201911295506.9, filed on Dec. 16, 2019. The entirety of the above-mentioned patent application is hereby incorporated by reference herein and made a part of this specification.

### BACKGROUND

### Technical Field

The disclosure relates to a display apparatus.

### Description of Related Art

With the vigorous development of electronic products, the display technology applied to the electronic products has also been continuously improved. Display apparatuses are constantly improving towards better display effects. With the vigorous development of such display apparatuses, consumers have high expectations for the quality, function, or reliability of these products. Nevertheless, the display apparatuses still do not meet the demands in all aspects. Although some display apparatuses exhibit display functions, development issues in terms of display quality, tolerance to environmental effects, and reliability may still be found in these display apparatuses.

### SUMMARY

The disclosure is directed to a display apparatus in which an adverse impact generated by short-wavelength light is reduced, a flickering phenomenon of the display apparatus is suppressed, and improved display quality and reliability is provided through a filter film capable of reducing a transmittance of a short-wavelength specific band.

The display apparatus according to an embodiment of the disclosure includes a panel and a filter film. The filter film is disposed on the panel. A resistance of the filter film is between 10³ ohm/sq and 10¹⁰ ohm/sq, and a transmittance of the filter film in a wavelength range from 380 nm to 420 nm is less than 100%.

According to another embodiment of the disclosure, a display apparatus includes a panel, a polarizer, and a filter film. The polarizer is disposed on the panel. The filter film is disposed on the panel. The transmittance of the filter film in a wavelength range from 380 nm to 420 nm is less than 100%.

Based on the foregoing, the display apparatus of an embodiment of the disclosure includes a filter film having a resistance between 10³ ohm/sq and 10¹⁰ ohm/sq and a transmittance of less than 100% in a wavelength range from 380 nm to 420 nm. Accordingly, arrangement of such a filter film on a panel may endow the functions of resisting static electricity and reducing short-wavelength light. As such, the situation of unfavorable display effect such as flickering caused by the impact of short-wavelength light on the panel is improved, and the display quality and reliability of the display apparatus is thereby enhanced. In some embodiments, the display apparatus includes a panel, a polarizer, and a filter film having a transmittance of less than 100% in a wavelength range from 380 nm to 420 nm. Arrangement of such a filter film on the panel and the polarizer has the function of reducing short-wavelength light. As such, the situation of unfavorable display effect such as flickering caused by the impact of short-wavelength light on the panel is improved, and the display quality and reliability of the display apparatus is thereby enhanced.

### BRIEF DESCRIPTION OF THE DRAWINGS

The accompanying drawings are included to provide a further understanding of the disclosure, and are incorporated in and constitute a part of this specification. The accompanying drawings illustrate embodiments of the disclosure and, together with the description, serve to explain the principles of the disclosure.

Each of FIG. 1A and FIG. 1B is a cross-sectional schematic view of a display apparatus according to an embodiment of the disclosure.

FIG. 2 is a transmittance spectrogram of a filter film in a display apparatus according to an embodiment of the disclosure.

FIG. 3 is a transmittance spectrogram of a filter film having different contents of short-wave absorbents in an embodiment of the disclosure.

FIG. 4 is a cross-sectional schematic view of a display apparatus in an embodiment of the disclosure.

FIG. 5 is a partial cross-sectional schematic view of a display apparatus according to another embodiment of the disclosure.

FIG. 6 is a partial cross-sectional schematic view of a display apparatus according to yet another embodiment of the disclosure.

FIG. 7 is a partial cross-sectional schematic view of a display apparatus according to yet another embodiment of the disclosure.

### DESCRIPTION OF THE EMBODIMENTS

A structure (or layer, component, substrate) being located on another structure (or layer, component, substrate) described in the disclosure may mean that two structures are adjacent and directly connected, or may mean that two structures are adjacent and indirectly connected. Indirect connection means that there is at least one intermediate structure (or intermediate layer, intermediate component, intermediate substrate, intermediate spacing) between two structures, the lower surface of a structure is adjacent or directly connected to the upper surface of the intermediate structure, and the upper surface of the other structure is adjacent or directly connected to the lower surface of the intermediate structure. The intermediate structure may be a single-layer or multi-layer physical structure or non-physical structure, which is not limited. In the disclosure, when a structure is disposed “on” another structure, it may mean that a structure is “directly” disposed on another structure, or a structure is “indirectly” disposed on another structure, that is, at least one structure is sandwiched between a structure and another structure. When a structure is referred to as being “directly disposed on another structure or film, or “directly connected to another structure or film”, there is no component or film inserted between the two structures or films.

The terms such as “first”, “second”, “third”, etc. may be used to describe components, but the components should not be limited by these terms. The terms are only intended to distinguish a component from another component in the specification. It is possible that the claims do not use the same terms and replace the terms with “first”, “second”, “third” etc. according to the sequence declared in the claims. Accordingly, in the specification, a first component may be a second component in the claims.

Herein, the terms “about”, “approximately”, “substantially”, and “essentially” usually mean within 10%, or within 5%, or within 3%, or 2% or within 1%, or within 0.5% of a given value or range. The quantity given here is an approximate quantity, that is, the meaning of “about”, “approximately”, “substantially”, and “essentially” can still be implied without specifying the terms “about”, “approximately”, “substantially”, and “essentially”. In addition, the terms “a range from a first value to a second value” and “a range between a first value and a second value” indicate that the range includes the first value, the second value, and other values in between.

In the disclosure, the transmittance and the multilayer film may be measured by using a cross-sectional image in an optical instrument and a scanning electron microscope, but are not limited thereto.

In the disclosure, the following embodiments may be used in any combination without departing from the spirit and scope of the disclosure. For example, some features of one embodiment may be combined with some features of another embodiment to form another embodiment.

Exemplary embodiments of the disclosure are described in detail, and examples of the exemplary embodiments are shown in the accompanying drawings. Whenever possible, the same component symbols are used in the drawings and descriptions to indicate the same or similar parts.

Each of FIG. 1A and FIG. 1B is a schematic view of a display apparatus according to an embodiment of the disclosure. Referring to FIG. 1A and FIG. 1B, a display apparatus 10A may include a panel 12 and a filter film 16. The filter film 16 is disposed on the panel 12, and the transmittance of the filter film 16 in a wavelength range from 380 nm to 420 nm is less than 100%. In addition, in one of the embodiments, the filter film 16 may optionally have a resistance between 10³ ohm/sq and 10¹⁰ ohm/sq. In another aspect, in the embodiment of FIG. 1B, the filter film 16 is disposed on a polarizer, and the transmittance of the filter film 16 in a wavelength range from 380 nm to 420 nm is less than 100%. In addition, in one of the embodiments, the filter film 16 may optionally have a resistance between 10³ ohm/sq and 10¹⁰ ohm/sq. In other words, the filter film 16 of FIG. 1B is a film layer that has a filter function and is different from a polarizer 14. The embodiments of FIG. 1A and FIG. 1B are described in detail later respectively.

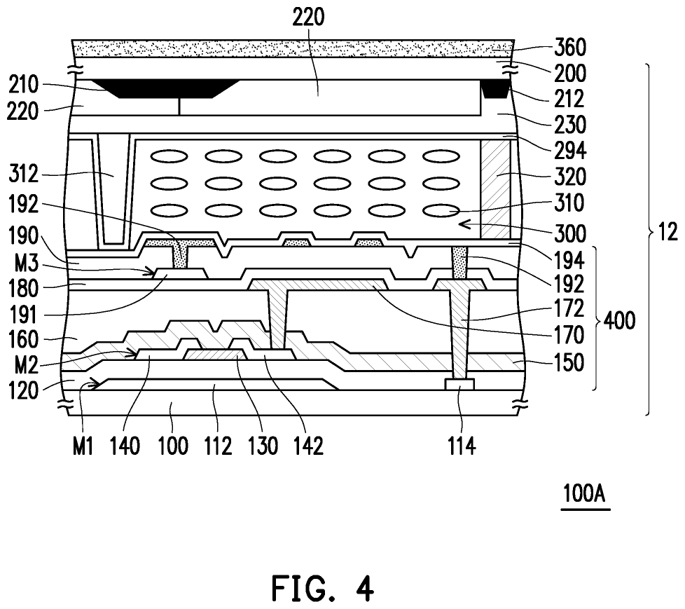

In FIG. 1A and FIG. 1B, the panel 12 may include a first substrate 100 and a second substrate 200 disposed opposite to each other, and at least include, but is not limited to, a display medium layer 300 and a driving layer 400 disposed between the two substrates, referring to FIG. 4 to FIG. 7 hereinafter. In some embodiments, the first substrate and the second substrate may be rigid substrates or flexible substrates. The materials of the first substrate and the second substrate may include, for example, glass, quartz, sapphire, ceramic, plastic, or other suitable materials, or a combination of the foregoing. Plastic materials include, for example but is not limited thereto, polyimide (PI), polycarbonate (PC) or polyethylene terephthalate (PET), liquid-crystal polymers (LCP) or other suitable materials, or a combination of the foregoing materials. The driving layer 400 may be used to drive the display medium layer. A material of the display medium layer includes, but not limited thereto, a liquid crystal material, an electrowetting display material, an electrophoretic display material, an organic light-emitting material, an inorganic light-emitting material, a quantum dot (QD) material, a fluorescence material, a phosphor material, other suitable materials, or a combination of the foregoing materials.

Referring to FIG. 1A, the filter film 16 may be disposed on an outer surface 12a of the panel. In the present embodiment, the filter film 16 may optionally have a resistance between 10³ ohm/sq and 10¹⁰ ohm/sq. In detail, the filter film 16 has a resistance between 10³ ohm/sq and 10¹⁰ ohm/sq, and may have a function of resisting static electricity, and the transmittance of the filter film in a wavelength range from 380 nm to 420 nm is less than 100%. Light in a wavelength range from 380 nm to 420 nm may be reduced, for example, the transmittance at a wavelength band of 410 nm may be reduced to 6%, and the transmittance at a wavelength band of 405 nm may be reduced to 3%. The adverse impacts of short-wavelength light on the display performance of the panel are reduced. Therefore, in the present embodiment, the filter film 16 in the display apparatus 10A can endow the functions of resisting static electricity and reducing short-wavelength light. As such, the situation of unfavorable display effect such as flickering caused by the impact of short-wavelength light on the panel is improved, and the display quality and reliability of the display apparatus is thereby enhanced.

FIG. 1B is a schematic view of a display apparatus according to another embodiment of the disclosure. Referring to FIG. 1B, a display apparatus 10B includes a panel 12, a polarizer 14, and a filter film 16. The polarizer 14 is disposed on the panel 12. The filter film 16 is disposed on the polarizer 14. In the present embodiment, the transmittance of the filter film 16 in a wavelength range from 380 nm to 420 nm is less than 100%, and the filter film 16 is a film layer different from the polarizer 14. Accordingly, in the present embodiment, the filter film 16 in the display apparatus 10B may reduce light, for example, in a wavelength range of 380 nm to 420 nm, and reduce the adverse impacts of short-wavelength light on the display performance of the panel, thereby improving the display quality and reliability of the display apparatus. The display apparatus 10B optionally includes another polarizer, disposed below the panel 12 (not shown).

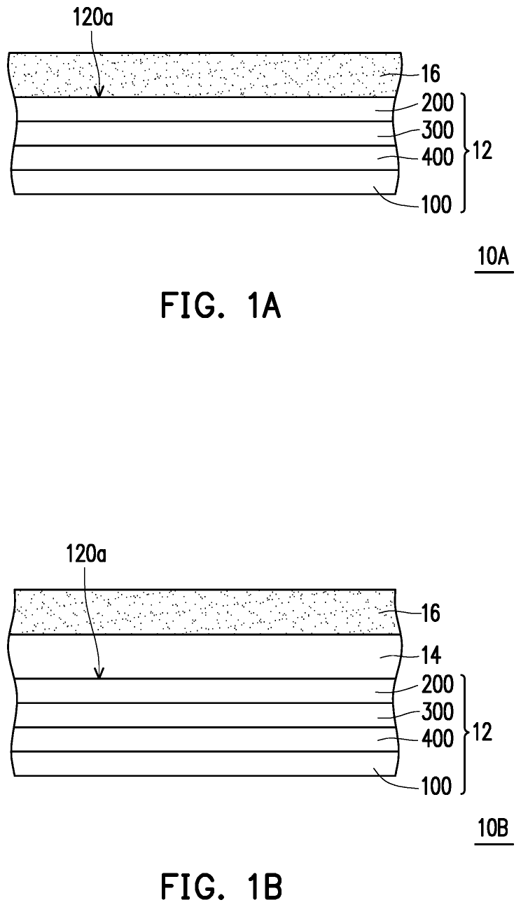

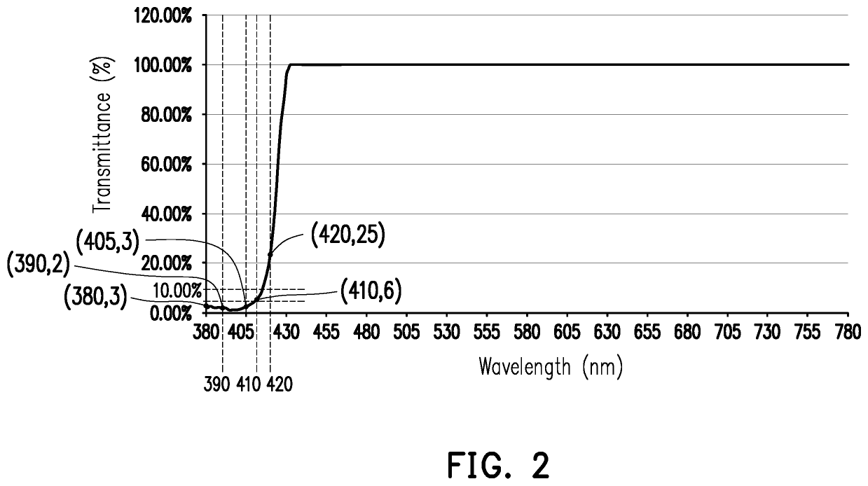

FIG. 2 is a transmittance spectrogram of a filter film in a display apparatus according to an embodiment of the disclosure. FIG. 2 shows a transmittance spectrogram of a filter film at different wavelengths. The transmittance of the filter film in FIG. 2 is a spectrogram normalized by taking the maximum transmittance of the filter film as 100%. In the present embodiment, the filter film is, for example, an inorganic multilayer film. The inorganic multilayer film of the filter film may be an inorganic material film that may reduce light having a wavelength range from 380 nm to 420 nm and is formed by a physical vapor deposition (PVD) coating mode. The material is, for example but not limited to, titanium dioxide (TiO₂) or silicon dioxide (SiO₂).

Referring to FIG. 2, the filter film may reduce short-wavelength light in a wavelength range from 380 nm to 420 nm, so that the impact of external short-wavelength light on the display performance of the panel may be reduced, the adverse impact on the display apparatus such as flickering may be lowered, and the reliability of the display apparatus may be improved. In more detail, the transmittance of the filter film in a wavelength range from 380 nm to 420 nm may be less than 100%. As shown in FIG. 2, the transmittance of the filter film decreases as the wavelength increases from 380 nm to about 400 nm, and then increases as the wavelength increases to 420 nm. In an embodiment, the transmittance of the filter film in a wavelength range from 380 nm to 420 nm may be approximately less than 25%. In another embodiment as shown in FIG. 2, the transmittance of the filter film in a wavelength range from 380 nm to 410 nm may be less than or equal to 10%. In another embodiment, the transmittance of the filter film in a wavelength range from 380 nm to 405 nm may be less than or equal to 5%. For example, the transmittance of the filter film in a wavelength range from 420 nm is about 25%, the transmittance in a wavelength range from 410 nm is about 6%, the transmittance in a wavelength range from 405 nm is about 3%, the transmittance in a wavelength range from 390 nm is about 2%, and the transmittance of the filter film in a wavelength range from 380 nm is about 3%.

Therefore, the filter film of the present embodiment may achieve the effect of reducing material aging caused by external short-wavelength light irradiating an inner layer of the panel to reduce the impact of short-wavelength light on the display performance, reduce the adverse impacts on the display apparatus such as flicker, and increase the reliability of the display apparatus.

Table 1 shows measurement results of flickering of the display apparatus in an embodiment of the disclosure. The filter film in Table 1 is shown in FIG. 2. Table 1 shows an irradiation experiment on the filter film and confirms a flicker variation of the filter film used in the display apparatus. The only difference between Comparative Examples 1 and 2 and Examples 1 and 2 is that Comparative Examples 1 and 2 do not use the foregoing filter film. The display apparatuses of Comparative Examples 1 and 2 include the same panel and polarizer, and only two measurements are performed on the display apparatus of the same configuration. In Examples 1 and 2, the filter film of the disclosure is added for measurement based on the configuration of Comparative Examples 1 and 2. The manner adopted for flicker measurement is, for example, driving the panel, switching to a flicker picture, measuring an initial value with a display color meter, switching to a white picture, switching to the flicker picture when irradiating for 1 h with sunlight, and then using the display color analyzer for measurement. If a variance value exceeds 18, it is considered bad. The measurement results are provided in Table 1 as follows.

TABLE 1

| | Irradiation Under Sunlight | | | Indoor | | |
|---|---|---|---|---|---|---|
| | | | Variance | | | Variance |
| | | | value | | | Value |
| | 0 hr | 1 hr | (Delta) | 0 hr | 1 hr | (Delta) |
| Comparative | −44.4 | −26.3 | 18.1 | −49.1 | −36.3 | 12.8 |
| Example 1 | | | | | | |
| Comparative | −44.4 | −25.1 | 19.3 | −44.8 | −34.3 | 10.5 |
| Example 2 | | | | | | |
| Example 1 | −40.2 | −29 | 11.2 | −49.1 | −36.3 | |
| Filter Film | | | | | | |
| Example 2 | −41.4 | −27.1 | 14.3 | −44.8 | −34.3 | |
| Filter Film | | | | | | |

It can be seen from Table 1 that compared with the variation value of Comparative Examples 1 and 2 exceeding an evaluation value of 18, it is confirmed that the display apparatuses of Examples 1 and 2 of the disclosure include the foregoing filter film having a specific transmittance in a specific band. Therefore, a flicker variation value can be reduced to be less than 18. Accordingly, it can be seen that in the display apparatus including the specific filter film of the disclosure, the phenomenon of unfavorable display effect of flickering of the panel is improved, and the display quality and reliability is enhanced.

In another embodiment, the filter film may be an organic film, but the disclosure is not limited thereto. More specifically, for the filter film, by adding a short-wavelength absorbent in an organic solution and by changing a content ratio of the short-wavelength absorbent in the organic solution, the transmittance of the filter film may be adjusted, and light in a specific wavelength range from 380 nm to 420 nm may be reduced, so as to obtain a filter film having a transmittance of less than 100% in a wavelength range from 380 nm to 420 nm.

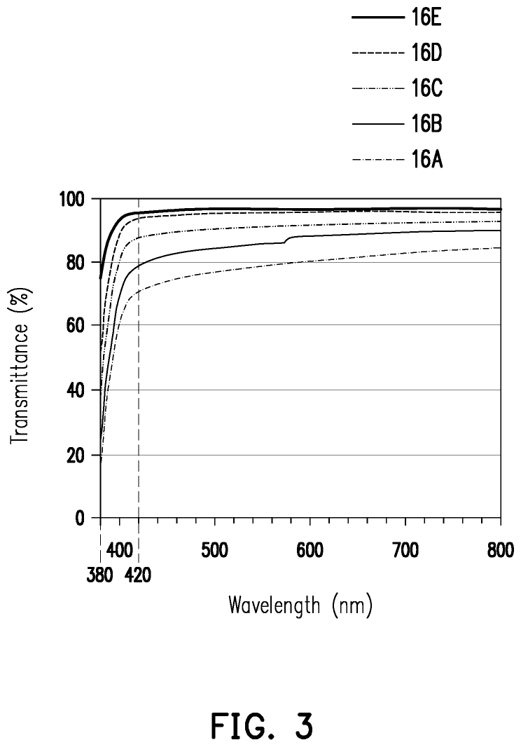

FIG. 3 is a transmittance spectrogram of a filter film having different contents of short-wave absorbents in an embodiment of the disclosure. FIG. 3 shows a transmittance spectrogram of a filter film in which filter films 16A to 16E sequentially represent a descending content of a short-wavelength absorbent. In detail, as shown in FIG. 3, the transmittance of the filter film at a wavelength of 380 nm may be about 20-80%, and the transmittance at a wavelength of 420 nm may be about 70-96%. It can be seen from FIG. 3 that compared with the organic filter film 16E with a low content of short-wavelength absorbent, the transmittance of the organic filter film 16A with a high content of short-wavelength absorbent may be reduced by about 15-60% in a wavelength range from 380 nm to 420 nm.

It can be seen from FIG. 3 that the overall transmittance (greater than the average of 420 nm to 800 nm) of the organic filter film 16A with the highest content of short-wavelength absorbent is about 80%, and the transmittance in a wavelength range from 380 nm to 420 nm is about 20% to about 70%. The overall transmittance of the organic filter film 16E with the lowest content of short-wavelength absorbent is about 95%, and the transmittance in a wavelength range from 380 nm to 420 nm is about 75% to about 95%. The overall transmittance of the organic filter film 16D with the second highest content of short-wavelength absorbent is about 90%, and the transmittance in a wavelength range from 380 nm to 420 nm is about 54% to about 94%. Therefore, by controlling the content of the short-wavelength absorbent in the organic filter film, a balance between the overall transmittance of the filter film and the transmittance in a wavelength range from 380 nm to 420 nm may be achieved. The material of the organic filter film is, for example, poly(3,4-ethylene dioxythiophene (PEDOT). The short-wavelength absorbent is, for example, a benzophenone derivative. The disclosure is not limited to thereto.

FIG. 4 is a cross-sectional schematic view of a display apparatus in an embodiment of the disclosure. Referring to FIG. 4, a display apparatus 100A includes a panel 12 and a filter film 360. The panel 12 may include a first substrate 100 and a second substrate 200, and a display medium layer 300 disposed between the two substrates 100 and 200. In the present embodiment, the filter film 360 is disposed on the other surface of the second substrate 200 opposite to the display medium 300. In more detail, a driving layer 400 for driving the display medium is disposed between the first substrate 100 and the display medium layer 300. In detail, the driving layer 400 may include a first conductive layer M1 including a gate 112 and a common line 114, a gate insulating layer 120, an active layer 130, a second conductive layer M2 including a source 140 and a drain 142, a first insulating layer 150, a first overcoat layer 160, a pixel electrode 170 and a shared electrode line 172, a second insulating layer 180, a touch signal line 191 (third conductive layer M3), a third insulating layer 190, and a touch electrode 192. In addition, a first alignment layer 194 is disposed between the touch electrode 192 and the display medium layer 300. The common line 114, the shared electrode line 172, and the touch electrode 192 are electrically connected. The touch electrode 192 and the touch signal line 191 are electrically connected. The touch electrode 192 receives a common voltage provided by the common line 114 during a display period, but receives a voltage for touch detection provided by the touch signal line 191 during the touch period.

In addition, as shown in FIG. 4, black matrices 210 and 212, a color filter layer 220, and a second overcoat layer 230 may be sequentially disposed between the second substrate 200 and the display medium layer 300 from the direction of the second substrate 200. In addition, a second alignment layer 294 is disposed between the second overcoat layer 230 and the display medium layer 300. A spacer 312 and a sealant 320 are disposed between the first substrate 100 and the second substrate 200. The spacer 312, such as a photo spacer, is used to support a distance between the first substrate and the second substrate. The space between the first substrate and the second substrate is a space for a display medium to fill. The display medium is, for example, liquid crystal 310, which may be twisted to different degrees with the voltage applied by the driving layer, thereby exhibiting different refractive indexes and controlling the flux of light through. Inner surfaces of the first substrate 100 and the second substrate 200 are jointed by the sealant 320. In addition, the materials of the first insulating layer 150, the second insulating layer 180, and the third insulating layer 190 may be inorganic materials, organic materials, or a combination of the foregoing, and may optionally have a protective function. In addition, the insulating layers have less uneven surfaces, and the electrodes may be smoothly disposed on the insulating layers, and thus the electrical properties are stable.

The display apparatus of FIG. 4 includes a filter film 360. In the present embodiment, the transmittance of the filter film 360 in a wavelength range from 380 nm to 420 nm is less than 100%. In some embodiments, the transmittance of the filter film 360 in a wavelength range from 380 nm to 420 nm is greater than or equal to 0%. The transmittance of the filter film 360 may be the same as the foregoing filter layer in FIG. 2, or the foregoing filter layer in FIG. 3, or the foregoing combination, and the disclosure is not limited thereto. In addition, the filter film 360 of the present embodiment may further optionally have a resistance between 10³ ohm/sq and 10¹⁰ ohm/sq, so that in addition to reducing short-wavelength light, it also has a function of resisting static electricity. In other words, the filter film 360 having a resistance between 10³ ohm/sq and 10¹⁰ ohm/sq may allow the display apparatus to discharge static electricity from the device while performing display or touch functions. Moreover, the filter film having a transmittance of less than 100% in a wavelength range from 380 nm to 420 nm may reduce short-band light having a wavelength range from 380 nm to 420 nm, and reduce the adverse effects of short-wavelength light on the display performance of the panel. In other words, in the present embodiment, the filter film may have the functions of resisting static electricity and reducing short-wavelength light between 380 nm and 420 nm.

In the present embodiment, the transmittance measurement method for the filter film is to perform measurement using, for example, a chromaticity spectrum analyzer, but the disclosure is not limited thereto. The resistance measurement method for the filter film is to measure the resistance of the filter film of the disclosure, such as 10⁸ ohm/sq or 10⁹ ohm/sq, using, for example, a high-impedance sheet resistance measuring machine, but the disclosure is not limited thereto.

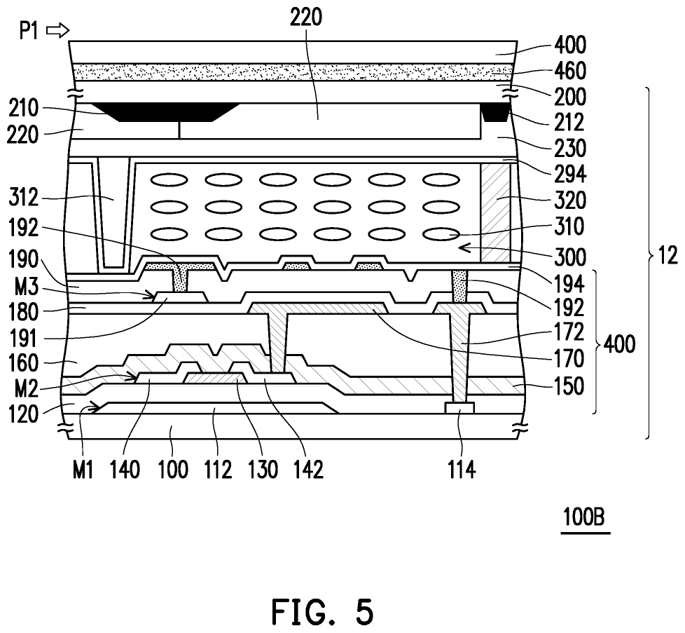

FIG. 5 is a partial cross-sectional schematic view of a display apparatus according to another embodiment of the disclosure. The embodiment of FIG. 5 uses the component numbers and partial content of the embodiment of FIG. 4, where the same or similar reference numbers are used to represent the same or similar components, and the description of the same technical content is omitted. For the description of the omitted parts, reference may be made to the description and effects of the foregoing embodiments. The following embodiments will not be repeated, and at least part of the descriptions not omitted in the embodiment of FIG. 5 may be referred to the subsequent content.

Referring to FIG. 5, a display apparatus 100B of the present embodiment includes a panel 12, a polarizer 400, and a filter film 460. In the present embodiment, the filter film 460 is a film layer different from the polarizer 400 that has the function of reducing short-wavelength light. In more detail, the transmittance of the filter film 460 in a wavelength range from 380 nm to 420 nm is less than 100%. In some embodiments, the transmittance of the filter film 360 in a wavelength range from 380 nm to 420 nm is greater than or equal to 0%. By providing the filter film 460 on the panel 12, it is possible to reduce the incidence of light in a short wavelength range of 380 nm to 420 nm into the panel. In the present embodiment, the resistance of the filter film 460 is not limited. In other words, in the present embodiment, as long as the filter film satisfies the function of reducing short-wavelength light between 380 nm and 420 nm, light in a wavelength range from 380 nm to 420 nm may be reduced, and the adverse impacts of short-wavelength light on the display performance of the panel can be reduced, thereby improving the display quality and reliability of the display apparatus.

In addition, the position of the filter film 460 in the present embodiment is described by, not limited to, taking as an example that the filter film is disposed between the panel 12 and the polarizer 400. The filter film 460 is not limited to be disposed between the panel 12 and the polarizer 400. In some embodiments, the filter film 460 may be disposed on an outer side of the polarizer, as shown in a position P1 in FIG. 5. In some other embodiments, the polarizer 400 may be disposed between the filter film 460 and the panel 12, and the disclosure is not limited thereto.

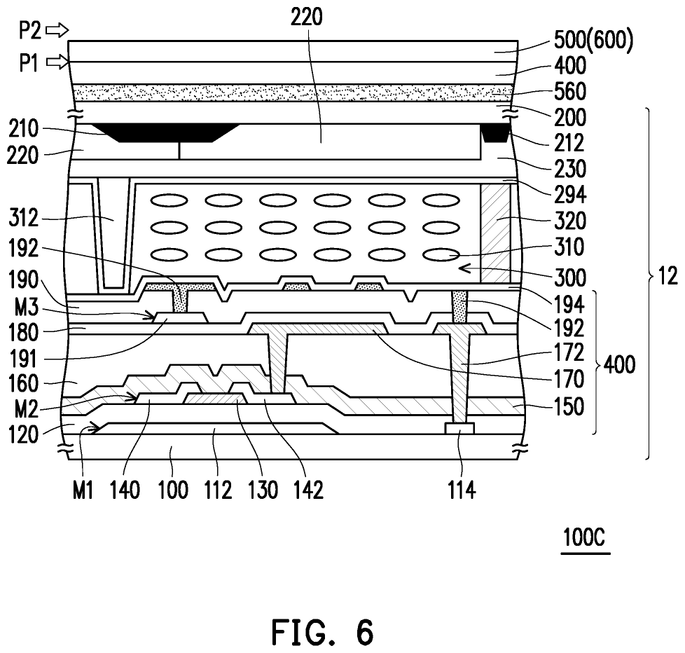

FIG. 6 is a partial cross-sectional schematic view of a display apparatus according to yet another embodiment of the disclosure. The embodiment of FIG. 6 uses the component numbers and partial content of the embodiment of FIG. 5, where the same or similar reference numbers are used to represent the same or similar components, and the description of the same technical content is omitted. For the description of the omitted parts, reference may be made to the description and effects of the foregoing embodiments. The following embodiments will not be repeated, and at least part of the descriptions not omitted in the embodiment of FIG. 5 may be referred to the subsequent content.

Referring to FIG. 6, a main difference between a display apparatus 100C of the present embodiment and the display apparatus 100B of the foregoing embodiments is that: the display apparatus 100C of the present embodiment may further include a transparency adhesive layer 500. The transparency adhesive layer 500 may be, for example, an optical clear adhesive (OCA) or other suitable adhesive materials. The transparency adhesive layer 500 is, for example, disposed on a polarizer. In this case, the transparency adhesive layer 500 may have a protective function, such as scratch resistance or reflection resistance. The filter film 560 of FIG. 6 is a film layer different from the polarizer 400 that has the function of reducing short-wavelength light. For the description of the position of the filter film 560, the filter film 560 is disposed, for example but not limited to, between the panel 12 and the polarizer 400. In some embodiments, the filter film 560 may also be disposed a position P1 between the polarizer 400 and the transparency adhesive layer 500. In some other embodiments, the filter film 560 may be disposed on an opposite surface of the transparency adhesive layer 500 with respect to the polarizer 400, as shown in a position P2 in FIG. 6. In addition, in other embodiments, the filter film may be disposed between the transparency adhesive layer 500 and the panel. In some other embodiments, the transparency adhesive layer may be disposed between the filter film and the panel.

In addition, in other embodiments, the display apparatus may also replace the transparency adhesive layer 500 in FIG. 6 with a protective cover 600. Specifically, the transparency adhesive layer 500 in FIG. 6 is replaced with the protective cover 600. In the present embodiment, the display apparatus includes a panel, a polarizer, and a protective cover without including the transparency adhesive layer 500. In such an implementation, the filter film 560 may be disposed between the panel 12 and the polarizer 400. In some embodiments, the filter film may be disposed between the polarizer 400 and the protective cover 600, as shown in a position P1 in FIG. 6. In some other embodiments, the filter film 560 may be disposed on an opposite surface of the protective cover 600 with respect to the polarizer 400, as shown in a position P2 in FIG. 6.

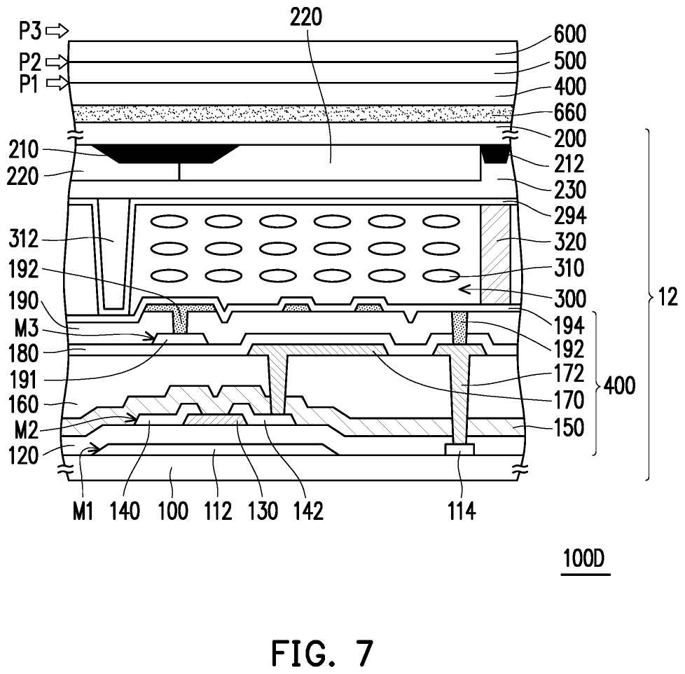

FIG. 7 is a partial cross-sectional schematic view of a display apparatus according to yet another embodiment of the disclosure. The embodiment of FIG. 7 uses the component numbers and partial content of the embodiment of FIG. 6, where the same or similar reference numbers are used to represent the same or similar components, and the description of the same technical content is omitted. For the description of the omitted parts, reference may be made to the description and effects of the foregoing embodiments. The following embodiments will not be repeated, and at least part of the descriptions not omitted in the embodiment of FIG. 6 may be referred to the subsequent content.

Referring to FIG. 7, a main difference between a display apparatus 100D of the present embodiment and the display apparatus 100C of the foregoing embodiment is that the display apparatus 100D of the present embodiment includes both a transparency adhesive layer 500 and a protective cover 600. The protective cover 600 is, for example but not limited to, cover glass. The protective cover 600 is, for example, disposed on the transparency adhesive layer 500, which may reduce damage to internal components of the panel by the external environment. In an implementation where the display apparatus 100D includes a polarizer 400, a transparency adhesive layer 500, and a protective cover 600, the filter film 660 of FIG. 7 is a film layer different from the polarizer 400 that has the function of reducing short-wavelength light. For the description of the position of the filter film 660, the filter film 660 is disposed, for example but not limited to, between the panel 12 and the polarizer 400. In some embodiments, the filter film 660 may also be disposed between the polarizer 400 and the transparency adhesive layer 500, as shown in a position P1 in FIG. 7. In some embodiments, the filter film 660 may be disposed between the transparency adhesive layer 500 and the protective cover 600, as shown in a position P2 in FIG. 7. In some other embodiments, the filter film 660 may be disposed on an opposite surface of the protective cover 600 with respect to the polarizer 400, as shown in a position P3 in FIG. 7.

According to the foregoing, the display apparatus provided by the embodiments of the disclosure may effectively reduce the impact of short-wavelength light on the display quality of the panel by providing the filter film having a transmittance of less than 100% in a wavelength range from 380 nm to 420 nm on the panel. Further, the advantages of reducing the adverse impacts of short-wavelength light on the display performance of the panel, improving the display quality, and enhancing the reliability of the display apparatus are also provided.

Although the disclosure has been described with reference to preferred aspects, a person of ordinary skill in the art should understand that changes may be made in form and detail without departing from the spirit and scope of the disclosure. The features of the embodiments may be used in any combination without departing from the spirit of the disclosure or conflicting with each other.

What is claimed is:

1. A display apparatus, comprising:
a panel; and
a filter film, disposed on the panel, wherein a resistance of the filter film is between 10³ ohm/sq and 10¹⁰ ohm/sq, and a transmittance of the filter film in a wavelength range from 380 nm to 420 nm is less than 100%.

2. The display apparatus according to claim 1, wherein the transmittance of the filter film in a wavelength range from 380 nm to 420 nm is less than 25%.

3. The display apparatus according to claim 1, wherein the transmittance of the filter film in a wavelength range from 380 nm to 420 nm is less than 10%.

4. The display apparatus according to claim 1, wherein the filter film comprises an inorganic multilayer film or an organic film having a short-wave absorbent.

5. A display apparatus, comprising:
a panel;
a polarize, disposed on the panel; and
a filter film, disposed on the panel, wherein a transmittance of the filter film in a wavelength range from 380 nm to 420 nm is less than 100%.

6. The display apparatus according to claim 5, wherein the transmittance of the filter film in a wavelength range from 380 nm to 420 nm is less than 25%.

7. The display apparatus according to claim 5, wherein the transmittance of the filter film in a wavelength range from 380 nm to 420 nm is less than 10%.

8. The display apparatus according to claim 5, wherein the filter film comprises an inorganic multilayer film or an organic film having a short-wave absorbent.

9. The display apparatus according to claim 5, wherein the filter film is disposed between the panel and the polarizer.

10. The display apparatus according to claim 5, further comprising a transparency adhesive layer, wherein the filter film is disposed between the transparency adhesive layer and the panel.

11. The display apparatus according to claim 5, further comprising a transparency adhesive layer, wherein the transparency adhesive layer is disposed between the filter film and the panel.

12. The display apparatus according to claim 5, further comprising a protective cover, wherein the filter film is disposed between the polarizer and the protective cover.

13. The display apparatus according to claim 5, further comprising a protective cover, wherein the filter film is disposed on the and protective layer.

14. The display apparatus according to claim 5, further comprising a transparency adhesive layer and a protective cover, wherein the transparency adhesive layer is disposed between the polarizer and the protective cover.

15. The display apparatus according to claim 14, wherein the filter film is disposed between the polarizer and the transparency adhesive layer.

16. The display apparatus according to claim 14, wherein the filter film is disposed between the transparency adhesive layer and the protective cover.

17. The display apparatus according to claim 5, wherein a resistance of the filter film is between 10³ ohm/sq and 10¹⁰ ohm/sq.

18. The display apparatus according to claim 5, comprising a first substrate and a driving layer, wherein the driving layer is disposed on the first substrate.

19. The display apparatus according to claim 14, wherein the driving layer comprises a touch signal line, a common line, and a touch electrode, and the touch electrode receives a common voltage provided by the common line during a display period and receives a voltage for touch detection provided by the touch signal line during the touch period.
